(19) United States
(12) Patent Application Publication
(10) Pub. No.: US 2025/0033448 A1
(43) Pub. Date: Jan. 30, 2025

(54) ATTACHMENT STRUCTURE FOR ROOF WEATHER STRIP

(71) Applicants: TOYODA GOSEI CO., LTD., Kiyosu-shi (JP); AISIN CORPORATION, Kariya (JP)

(72) Inventors: Ayumi KURACHI, Kiyosu-shi (JP); Taizo SHIBATA, Kiyosu-shi (JP); Satoshi MUGISHIMA, Kiyosu-shi (JP); Kazuhiko YOSHIZAWA, Kariya (JP)

(21) Appl. No.: 18/765,859

(22) Filed: Jul. 8, 2024

(30) Foreign Application Priority Data
Jul. 28, 2023 (JP) 2023-123071

(51) Int. Cl. B60J 10/90; B60J 10/24; B60J 10/33; B60J 10/36

(52) U.S. Cl. CPC B60J 10/90; B60J 10/24; B60J 10/33; B60J 10/36

(57) ABSTRACT

An inclined surface having an acute angle is formed in a vehicle downward direction on a second panel that is a fixed panel made of resin, and a weather strip attachment portion having a substantially L-shaped cross section is formed in the vehicle downward direction from a second panel lower surface of the second panel and in the direction of a first panel that is a movable panel, and a roof weather strip has an attachment base having a substantially U-shaped cross section and a hollow seal portion connected to the attachment base, and the attachment base is attached to the weather strip attachment portion.

### CROSS REFERENCE TO RELATED APPLICATION

This application claims the priority benefit of Japanese Patent Application No. 2023-123071 filed on Jul. 28, 2023. The entirely of the above-mentioned patent application is hereby incorporated by reference herein and made a part of this application.

### BACKGROUND OF THE INVENTION

### (1) Field of the Invention

The present invention relates to, in a roof of a vehicle having an opening portion that includes a movable panel that can be opened and closed and a fixed panel, an attachment structure for a roof weather strip that is attached to the fixed panel and seals between the fixed panel and an end portion of the movable panel.

### (2) Description of Related Art

In a roof of an automobile having an opening portion that includes a movable panel that can be opened and closed and a fixed panel, for example, those described in Japanese Patent Application Laid-Open No. 2012-62023, No. 2013-199143, and No. 2010-260394 are known as an attachment structure for a roof weather strip that is attached to a side of the fixed panel and seals between the fixed panel and an end portion of the movable panel. FIG. 4 shows a technique described in Japanese Patent Application Laid-Open No. 2012-62023. A roof device 100 includes a movable panel 120 that opens and closes an opening portion of a roof panel 110, and a roof weather strip 200 that is provided between an opening edge of the roof panel 110 and the movable panel 120 and seals between the opening edge and the movable panel 120. The opening edge of the roof panel 110 includes a flange portion 140 extending vertically downward from a roof panel body 130. The roof weather strip 200 includes an attachment base 210 that encloses the flange portion 140. Further, a guide rail 150 that is attached to the roof panel 110 and supports the movable panel 120 is provided with a clamping portion 160 that clamps the attachment base 210 of the roof weather strip 200. With the above configuration, since the assembled roof weather strip 200 is stably held through the clamping portion 160, reliability of the roof weather strip 200 can be improved.

FIG. 5 shows a technique described in Japanese Patent Application Laid-Open No. 2013-199143. The roof weather strip 200 includes an attachment base 210 that is attached to a distal end portion of a fixed base panel 180 to which the fixed panel 170 is attached, and a seal portion 190 that is in contact with the movable panel 120. The attachment base 210 includes a panel engagement portion 230 that engages with the distal end portion of the fixed base panel 180 and a rim engagement portion 250 that engages with a panel rim 240 attached to the distal end portion of the fixed panel 170. The panel engagement portion 230 is formed on a lower surface side of the attachment base 210, and the rim engagement portion 250 is formed on an upper surface side of the attachment base 210. With the above configuration, a side portion on a distal end side of the attachment base 210 is engaged with a distal end of the fixed base panel 180 by the panel engagement portion 230, the rim engagement portion 250 on the side of the fixed panel 170 of the attachment base 210 is engaged with the panel rim 240, and side ends on both sides of the attachment base 210 can be reliably attached.

FIG. 6 shows a technique described in Japanese Patent Application Laid-Open No. 2010-260394. The roof weather strip 200 includes a first weather strip portion 270, a second weather strip portion 280, and a coupling portion 290 that integrally connects the first weather strip portion 270 and the second weather strip portion 280. Further, a convex portion 320 that protrudes upward from the coupling portion 290 and extends in a longitudinal direction is formed to seal between a sliding roof panel 330 and a fixed roof panel 260. A double-sided adhesive tape 300 is attached below the first weather strip portion 270 and the second weather strip portion 280, and the roof weather strip 200 is attached to a base plate 340 by the double-sided adhesive tape 300.

### SUMMARY OF THE INVENTION

In a roof of an automobile having an opening portion that includes a movable panel that can be opened and closed and a fixed panel, as compared with a vehicle having no movable panel that can be opened and closed in the roof, an interior height, which is one of indices indicating a space in the vehicle, that is, a vertical maximum distance from a flat floor surface near a center portion of the vehicle to a ceiling lining is shortened by about 10 mm to 30 mm. Therefore, it has been reported that some people, especially tall people are dissatisfied with small head clearance.

Further, in electric vehicles (EVs), which have been rapidly expanding in recent years, a battery is often mounted under a floor, which means that the floor surface is located upward, and a seat surface is also moved upward accordingly, so that the head clearance of a passenger is further reduced. Therefore, in a vehicle having a movable panel that can be opened and closed in the roof, narrowness of the head clearance may be a significant problem.

Further, from a viewpoint of weight reduction of the vehicle, it is also important to use resin for the panel and to reduce the size of an attachment portion of the roof weather strip. Furthermore, in a case where the roof weather strip is attached to a resin panel by adhesion, degreasing treatment or primer processing of the surface of the resin panel is required, and workability during assembly is poor. Further, in the case of the double-sided adhesive tape, water leakage due to peeling from the panel or the roof weather strip due to deterioration of the tape, and panel malfunction due to peeling of the roof weather strip also become problems.

According to a first disclosed aspect includes, an attachment structure for a roof weather strip, in which
at least two panels are disposed on a roof of a vehicle,
a first panel is a movable panel configured to be able to open and close an opening portion of the roof, a second panel is a fixed panel that is made of resin and fixedly disposed adjacent to a vehicle front side or a vehicle rear side of the first panel, an inclined surface having an acute angle is formed at a second panel end portion of the second panel on a side of the first panel in a vehicle downward direction from the side of the first panel in a vehicle vertical direction, a weather strip attachment portion having a substantially L-shaped cross section is formed in the vehicle downward direction from a second panel lower surface of the second panel and in the direction of the first panel, the roof weather strip includes an attachment base having a substantially U-shaped cross section and a hollow seal portion connected to the attachment base, and the attachment base is attached to the weather strip attachment portion.

According to the first disclosed aspect, the weather strip attachment portion having a substantially L-shaped cross section is formed in the vehicle downward direction from the second panel lower surface of the second panel and in the direction of the first panel, the roof weather strip includes the attachment base having a substantially U-shaped cross section and the hollow seal portion connected to the attachment base, and the attachment base is attached to the weather strip attachment portion, therefore, the workability during attachment is improved as compared with a case where the roof weather strip is attached by adhesion, and defects such as water leakage due to deterioration after attachment due to adhesion and peeling of the roof weather strip can be eliminated.

Further, since the weather strip attachment portion has a substantially L-shaped cross section in the vehicle downward direction from the second panel lower surface of the second panel and in the direction of the first panel, the attachment base of the roof weather strip can be located higher in the vehicle as compared with a case where the weather strip attachment portion is formed perpendicular to the second panel. As a result, the interior height can be increased in a vehicle having an opening portion in the roof that includes a movable panel that can be opened and closed and a fixed panel.

Further, since the inclined surface having an acute angle is formed at the second panel end portion of the second panel on the side of the first panel in the vehicle downward direction from the side of the first panel in the vehicle vertical direction, the hollow seal portion can be disposed including a space in the vehicle downward direction of the inclined surface. As a result, when the hollow seal portion is brought into contact with the first panel, the hollow seal portion can be deformed without generating a load such as excessive bending. Further, since the space in the vehicle downward direction of the inclined surface is used, a space between the first panel and the second panel can be narrowed. Furthermore, it is possible to easily perform control for preventing the hollow seal portion from protruding upward from the vehicle between the first panel and the second panel and impairing an appearance of the roof.

Here, the “movable panel” refers to a panel that is movable in a front-rear direction of the vehicle so as to be able to open and close an opening portion formed in the roof of the vehicle. Further, the “fixed panel” refers to a panel that is attached to the roof of the vehicle and does not move in the front-rear direction of the vehicle. Note that, the fixed panel includes an operation in which the side of the movable panel of the fixed panel moves upward of the vehicle when the movable panel opens the opening portion.

According to a second disclosed aspect includes, an attachment structure for a roof weather strip, in which a protruding portion is formed in the weather strip attachment portion, an engagement portion is formed inside an opening of the attachment base, and the protruding portion and the engagement portion are engaged with each other.

According to the second disclosed aspect, the protruding portion is formed in the weather strip attachment portion, the engagement portion is formed inside the opening of the attachment base, and the protruding portion and the engagement portion are engaged with each other, therefore, even when a force in the front-rear direction of the vehicle is applied to the attachment base due to deformation of the hollow seal portion when the first panel is opened and closed, the attachment base can be prevented from moving in the front-rear direction of the vehicle.

Incidentally, although the first panel can be opened and closed, a time period during which the first panel is left in a closed state, that is, in a state where the hollow seal portion and the end portion of the first panel are in contact with each other, is generally long. Therefore, there is a case where the hollow seal portion and the end portion of the first panel are fixed to each other, and when the first panel is opened in a state where the hollow seal portion and the end portion of the first panel are fixed to each other, the hollow seal portion is pulled in the front-rear direction of the vehicle, and accordingly, the attachment base connected to the hollow seal portion is also pulled in the front-rear direction, and there is a possibility that the attachment base comes off from the weather strip attachment portion.

Even in this case, since the protruding portion and the engagement portion are engaged with each other, even when the hollow seal portion is pulled in the front-rear direction of the vehicle, and the attachment base connected to the hollow seal portion is pulled in the front-rear direction, it is possible to prevent the attachment base from coming off from the weather strip attachment portion.

According to a third disclosed aspect includes, an attachment structure for a roof weather strip in which at least one of an upper bulging portion and a lower bulging portion is formed on a side surface on a non-opening side of the attachment base, hardness of the upper bulging portion and the lower bulging portion is lower than that of a member constituting the attachment base, the upper bulging portion is in contact with the second panel lower surface, and the lower bulging portion is in contact with a housing disposed in the vehicle downward direction of the second panel.

According to the third disclosed aspect, at least one of the upper bulging portion and the lower bulging portion is formed on the side surface on the non-opening side of the attachment base, the hardness of the upper bulging portion and the lower bulging portion is lower than that of the member constituting the attachment base, the upper bulging portion is in contact with the second panel lower surface, and the lower bulging portion is in contact with a housing disposed in the vehicle downward direction of the second panel, therefore, the upper bulging portion bends when it comes into contact with the second panel lower surface, and a space between the attachment base and the second panel lower surface is sealed, so that it is possible to prevent water from entering. Further, the upper bulging portion serves as a downward biasing force, which can stabilize an attachment position of the roof weather strip and reliably fix the attachment base of the roof weather strip to the weather strip attachment portion. Further, even when the attachment base deteriorates over time, it is possible to prevent the distal end portion on an opening side of the attachment base having a substantially U-shaped cross section from expanding and the attachment base from being easily detached from the weather strip attachment portion.

On the other hand, the lower bulging portion bends when it comes into contact with the housing, a space between the attachment base and the housing is sealed, and when the first panel, being a movable panel, is opened, water adhering to the hollow seal portion can be prevented from entering the attachment base and the housing in a case where the water flows downward on the surface of the hollow seal portion or in a case where the water bounces back at a lower position.

Note that, in the third disclosed aspect, since at least one of the upper bulging portion and the lower bulging portion is formed on the side surface on the non-opening side of the attachment base, a case where only the upper bulging portion is formed, a case where only the lower bulging portion is formed and a case where both the upper bulging portion and the lower bulging portion are formed are included.

### BRIEF DESCRIPTION OF THE DRAWINGS

FIG. 1 is a plan view of a roof of a vehicle as viewed from above the vehicle;

FIG. 2 is a cross-sectional view of a roof weather strip according to an embodiment of the present invention;

FIG. 3 is a cross-sectional view taken along an A-A line in FIG. 1 when the roof weather strip according to the embodiment of the present invention is attached to a second panel and a first panel is closed;

FIG. 4 is a cross-sectional view showing a conventional form (Japanese Patent Application Laid-Open No. 2012-62023);

FIG. 5 is a cross-sectional view showing a conventional form (Japanese Patent Application Laid-Open No. 2013-199143); and

FIG. 6 is a cross-sectional view showing a conventional form (Japanese Patent Application Laid-Open No. 2010-260394).

### DETAILED DESCRIPTION OF PREFERRED EMBODIMENTS

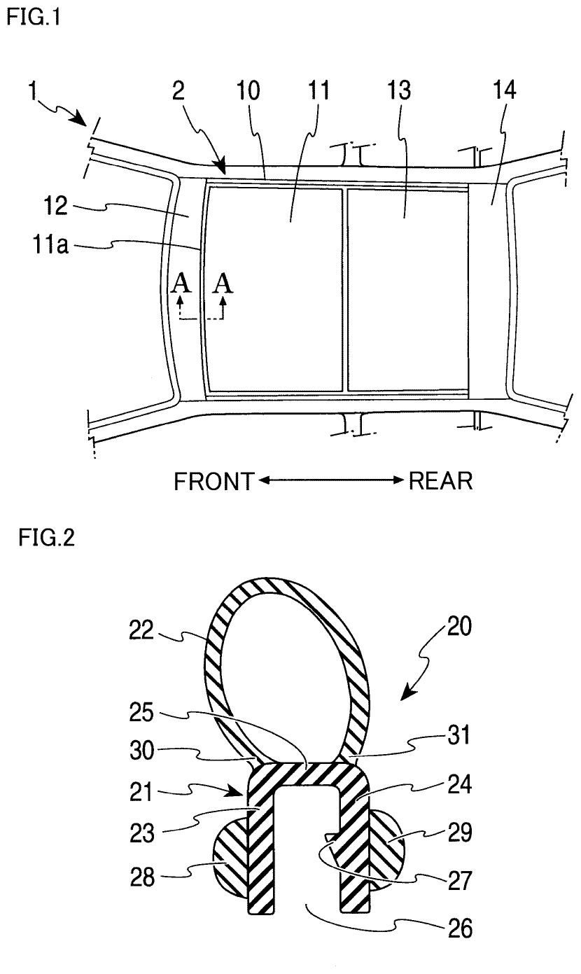

An embodiment of the present invention will be described with reference to FIGS. 1 to 3. Note that, hereinafter, the front-rear direction of a vehicle 1 is referred to as a “front-rear direction”, and an upper side and a lower side in a height direction of the vehicle 1 are referred to as an “upper side” and a “lower side”, respectively. Further, a width direction of the vehicle 1 is referred to as a “width direction”.

FIG. 1 is a plan view of a roof 2 of the vehicle 1 as viewed from above the roof 2. The vehicle 1 is a sedan type automobile, the roof 2 is divided into four by panels in the front-rear direction, a first panel 11 is a movable panel, and a second panel 12, a third panel 13, and a fourth panel 14 are fixed panels, which is a type called a so-called panoramic roof (panoramic moonroof). The first panel 11 and the third panel 13 are made of a glass plate, and by moving a cover of the glass plate on a vehicle interior side, it is possible to enhance a sense of openness inside the vehicle in a wide area and to take light into the vehicle. Note that, the vehicle 1 is not limited to a sedan type automobile, and the roof 2 is not limited to a panoramic roof type.

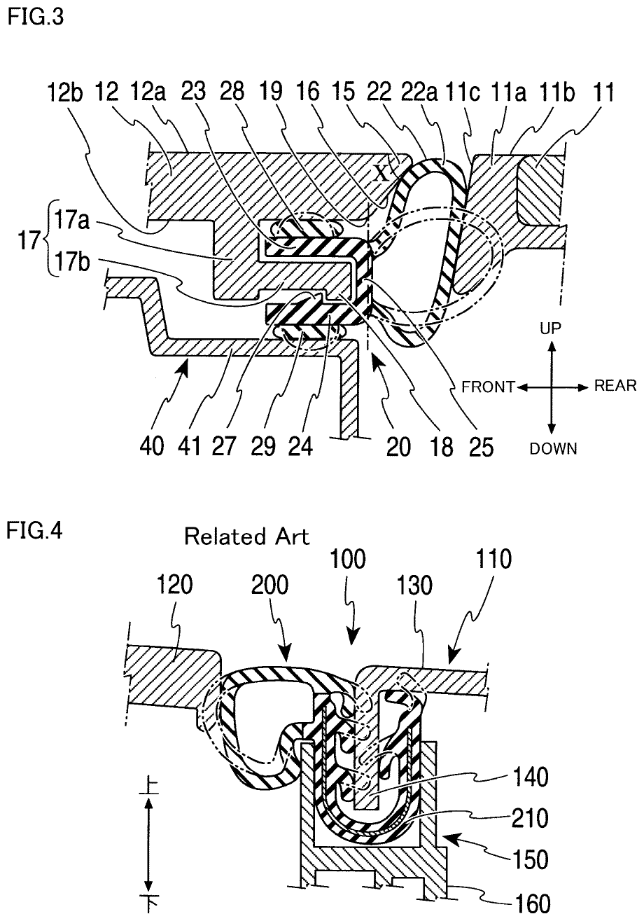

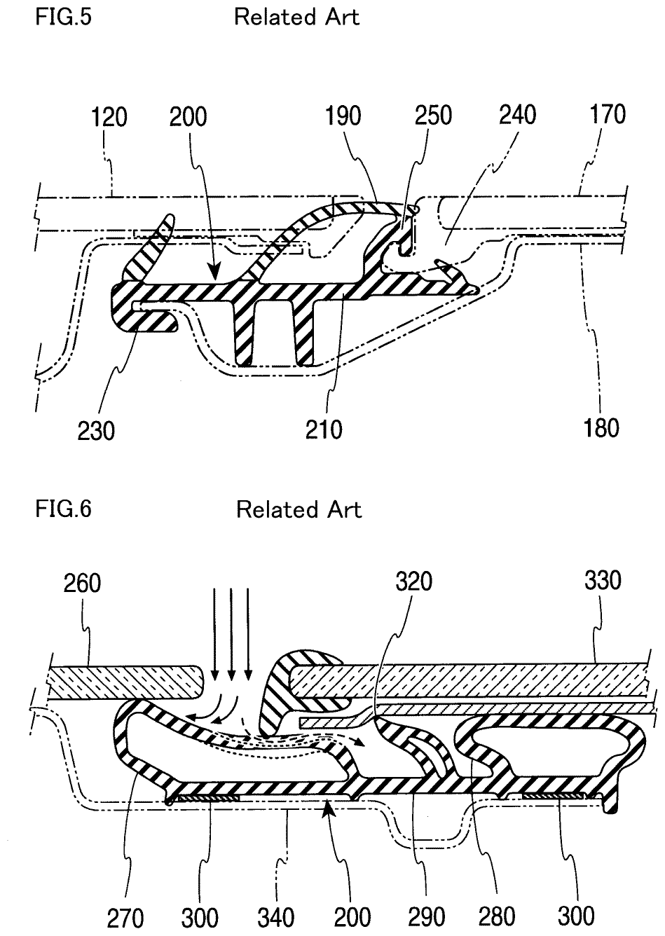

The first panel 11 is attached so as to be able to open and close an opening portion 10. In other words, the first panel 11 is attached so as to be capable of performing a tilt-up operation in which its rear portion is raised with its front portion as a fulcrum and a sliding operation in the front-rear direction. In an opening/closing operation by the first panel 11, a so-called outer sliding type in which the first panel 11 slides while remaining in a tilted-up state is adopted. In the first panel 11, a first panel edge portion 11a (FIG. 3) that has a substantially quadrangular annular shape made of a polyurethane resin material along periphery of the first panel 11 and corresponds to an end portion on the side of the second panel 12 is formed. Note that, the resin material of first panel edge portion 11a is not limited to polyurethane.

On the other hand, the second panel 12 is located in front of the first panel 11 and is attached so as to block a front portion of the opening portion 10. The second panel 12 is configured so that when the first panel 11 moves rearward, the first panel 11 side thereof is lifted upward in order to adjust entrance of wind into the vehicle. Note that, the second panel 12 may have a configuration in which the first panel 11 side thereof is not lifted upward.

FIG. 2 is a cross-sectional view of a roof weather strip 20. The roof weather strip 20 has an attachment base 21 and a hollow seal portion 22 connected to the attachment base 21. The attachment base 21 has a substantially U-shaped cross section in which a first vertical side portion 23 and a second vertical side portion 24 are connected by a coupling portion 25.

An upper bulging portion 28 is formed in a semicircular shape on an outer side surface of the first vertical side portion 23 of the attachment base 21 (a side surface of the first vertical side portion 23 that is not on the side of an opening 26 (non-opening side)). Note that, the shape of the upper bulging portion 28 is not limited to a semicircular shape. The upper bulging portion 28 is formed of a material having hardness lower than that of a member constituting the first vertical side portion 23.

A lower bulging portion 29 is formed in a semicircular shape on an outer side surface of the second vertical side portion 24 of the attachment base 21 (a side surface of the second vertical side portion 24 that is not on the side of the opening 26 (non-opening side)). Note that, the shape of the lower bulging portion 29 is not limited to a semicircular shape. The lower bulging portion 29 is formed of a material having hardness lower than that of the member constituting the second vertical side portion 24.

An engagement portion 27 is formed inside the opening 26 of the attachment base 21 and on an inner side surface of the second vertical side portion 24 (a side surface of the second vertical side portion 24 on the side of the opening 26). The engagement portion 27 has a substantially right-angled triangular shape in which a degree of protrusion from the inner side surface of the second vertical side portion 24 decreases as the distance from the coupling portion 25 increases. Note that, an oblique side of the substantially right-angled triangle may have an arc shape.

The hollow seal portion 22 is connected to the attachment base 21 at a first end portion 30 and a second end portion 31, which are two end portions, and has a substantially D-shaped cross section. The first end portion 30 is connected to a position across the first vertical side portion 23 and the coupling portion 25, and the second end portion 31 is connected to the coupling portion 25. Note that, the connection portion between the first end portion 30 and the second end portion 31 with the attachment base 21 is not limited to the above position.

The roof weather strip 20 is formed by extrusion molding such that the cross section in FIG. 2 is continuously formed in the width direction in FIG. 1. Ethylene propylene diene rubber (EPDM) was used as a material of the roof weather strip 20, a solid material was used for the attachment base 21, and a sponge material was used for the hollow seal portion 22, the upper bulging portion 28, and the lower bulging portion 29. The hardness of the solid material is an international rubber hardness degree (IRHD) of 60 or more. Further, the hollow seal portion 22 has a specific gravity of 0.4 or more and 1.0 or less. In the present embodiment, sponge materials having the same hardness were used for the hollow seal portion 22, the upper bulging portion 28, and the lower bulging portion 29. Note that, it is preferable that the hardness of the upper bulging portion 28 and the lower bulging portion 29 is less than or equal to the hardness of the hollow seal portion 22 from a viewpoint of ease of bending in contact with a second panel lower surface 12b (FIG. 3) in the upper bulging portion 28 and in contact with a housing 50 (FIG. 3) in the lower bulging portion 29.

FIG. 3 is a cross-sectional view taken along an A-A line in FIG. 1 when the roof weather strip 20 according to the embodiment of the present invention is attached to the second panel 12 and the first panel 11 is closed. The second panel 12 is made of resin. In the second panel 12, an inclined surface 16 having an acute angle X is formed at a second panel end portion 15 on the side of the first panel 11 in a downward direction from the side of the first panel 11. Further, an angle formed by a first panel upper surface 11b and a first panel side surface 11c of the first panel edge portion 11a is 100 degrees. Note that, the angle formed by the first panel upper surface 11b and the first panel side surface 11c is not limited to 100 degrees.

Further, a weather strip attachment portion 17 having a substantially L-shaped cross section is formed downward from the second panel lower surface 12b of the second panel 12 and in the direction of the first panel 11. The weather strip attachment portion 17 in a substantially L-shaped shape includes a projecting portion 17a that projects substantially vertically downward from the second panel lower surface 12b, and a mounting portion 17b that extends substantially parallel to the second panel lower surface 12b from a lower distal end portion of the projecting portion 17a, and a protruding portion 18 that protrudes downward and engages with the engagement portion 27 formed in the attachment base 21 of the roof weather strip 20 is formed at the distal end portion of the mounting portion 17b on the side of the first panel 11. Note that, the upper bulging portion 28 is formed in a semicircular shape on the outer side surface of the first vertical side portion 23 of the attachment base 21, and since the upper bulging portion 28 bends and comes into contact with the second panel lower surface 12b of the second panel 12, in order to engage the engagement portion 27 formed on the second vertical side portion 24 with the protruding portion 18, it is necessary to open the second vertical side portion 24 on the side of the opening 26 to allow the protruding portion 18 to pass through. Therefore, it is preferable that the protruding portion 18 is formed on a lower side of the mounting portion 17b.

Further, when the protruding portion 18 and the engagement portion 27 are engaged with each other, the attachment base 21 can be stably attached to the mounting portion 17b when the protruding portion 18 matches the shape of the joined portion between the second vertical side portion 24 and the coupling portion 25, therefore, it is preferable that the protruding portion 18 is formed in a rectangular shape, in particular, a rectangular shape or a square shape at the distal end portion of the mounting portion 17b.

It is preferable that the distal end portion of the mounting portion 17b on the side of the first panel 11 is formed so that when the attachment base 21 of the roof weather strip 20 is attached to the mounting portion 17b, the outer side surface (the surface on the non-opening side) of the coupling portion 25 of the attachment base 21 is near a connection portion 19 between the second panel lower surface 12b and the inclined surface 16 with a vertical downward direction interposed therebetween because the hollow seal portion 22 can be disposed by effectively utilizing the inclined surface 16. In FIG. 3, the outer side surface of the coupling portion 25 of the attachment base 21 is located slightly closer to the side of the first panel 11 than the vertical downward direction (a dashed-dotted line) of the connection portion 19.

In the present embodiment, the angle X between a second panel upper surface 12a and the inclined surface 16 is 50 degrees. Note that, the angle X between the second panel upper surface 12a and the inclined surface 16 is preferably 40 degrees to 60 degrees. In a case where the angle X is less than 40 degrees, although the length of the inclined surface 16 can be secured, it is necessary to form the hollow seal portion 22 large in the front-rear direction, and the weight of the roof weather strip 20 increases, which is not preferable. Further, when the angle X exceeds 60 degrees, the space between the inclined surface 16 and the first panel edge portion 11a becomes narrow, and accordingly, when the first panel 11 is closed, the degree of curvature of an upper end portion 22a during deformation increases in the hollow seal portion 22, and durability of the hollow seal portion 22 decreases, which is not preferable.

When the upper bulging portion 28 is attached to the mounting portion 17b of the weather strip attachment portion 17 from the opening side of the attachment base 21 of the roof weather strip 20, above the mounting portion 17b, the upper bulging portion bends and comes into contact with the first vertical side portion 23 of the attachment base 21 and the second panel lower surface 12b, and seals between the first vertical side portion 23 and the second panel lower surface 12b.

Further, below the mounting portion 17b, the protruding portion 18 formed on the mounting portion 17b and the engagement portion 27 formed on the second vertical side portion 24 of the attachment base 21 are engaged with each other. Since the engagement portion 27 has a substantially right-angled triangular shape in which the degree of protrusion of the second vertical side portion 24 from the side surface decreases as the distance from the coupling portion 25 increases, the attachment base 21 is easily inserted into the mounting portion 17b forward from the side of the first panel 11.

A housing 40 is disposed below the second panel 12. In the housing 40, a housing step portion 41 with a step on the lower side is formed on the side of the first panel 11. Further, the distal end portion of the housing step portion 41 is bent by 90 degrees with respect to the housing step portion 41 and extends downward.

When the housing 40 is disposed, the lower bulging portion 29 bends below the mounting portion 17b and comes in contact with the housing step portion 41 to seal between the second vertical side portion 24 and the housing step portion 41.

When the first panel 11 is closed, the hollow seal portion 22 of the roof weather strip 20 is pressed against the first panel edge portion 11a of the first panel 11 and deforms, and the hollow seal portion 22 comes in contact with the first panel edge portion 11a of the first panel 11 and the inclined surface 16 of the second panel 12.

Further, the upper end portion 22a of the hollow seal portion 22 is located below a line connecting the first panel upper surface 11b and the second panel upper surface 12a.

As described above in detail, according to the present embodiment, the following effects can be obtained.

(1) In the present embodiment, the roof weather strip 20 includes the attachment base 21 having a substantially U-shaped cross section and the hollow seal portion 22 connected to the attachment base 21, and the attachment base 21 is attached to the weather strip attachment portion 17 formed in the housing 50, therefore, the workability during attachment is improved as compared with attachment by adhesion of the roof weather strip 20, and defects associated with deterioration after attachment due to adhesion can be eliminated.

(2) In the present embodiment, since the hollow seal portion 22 is in contact with the first panel edge portion 11a of the first panel 11 and the inclined surface 16 of the second panel 12, it is possible to prevent water from entering the vehicle interior side from between the first panel 11 and the second panel 12.

(3) In the present embodiment, the weather strip attachment portion 17 has a substantially L-shaped cross section downward from the second panel lower surface 12b of the second panel 12 and in the direction of the first panel 11, and the weather strip attachment portion 17 in a substantially L-shaped shape includes the projecting portion 17a that projects substantially vertically downward from the second panel lower surface 12b and the mounting portion 17b that extends substantially parallel to the second panel lower surface 12b from the lower distal end portion of the projecting portion 17a, and the attachment base 21 of the roof weather strip 20 is attached to the mounting portion 17b that extends substantially parallel to the second panel lower surface 12b, therefore, the attachment base 21 of the roof weather strip 20 can be located higher in the vehicle as compared with a case where the weather strip attachment portion 17 is formed perpendicular to the second panel 12. As a result, the interior height can be increased in a vehicle having an opening portion in the roof that includes a movable panel that can be opened and closed and a fixed panel.

(4) In the present embodiment, since the inclined surface 16 having an acute angle is formed at the second panel end portion 15 of the second panel 12 on the side of the first panel 11 in the downward direction from the side of the first panel 11 in the vertical direction, the hollow seal portion 22 can be disposed including a space formed below the inclined surface 16. As a result, when the hollow seal portion 22 is brought into contact with the first panel 11, the hollow seal portion 22 can be deformed without generating a load such as excessive bending. Further, since the space below the inclined surface 16 is used, the space between the first panel 11 and the second panel 12 can be narrowed. Furthermore, it is possible to easily perform control for preventing the upper end portion 22a of the hollow seal portion 22 from protruding upward from between the first panel 11 and the second panel 12 and impairing the appearance of the roof.

(5) In the present embodiment, the protruding portion 18 that protrudes downward in a rectangular shape is formed at the distal end portion of the mounting portion 17b of the weather strip attachment portion 17 on the side of the first panel 11, the engagement portion 27 having a substantially right-angled triangular shape in which the degree of protrusion from the side surface of the second vertical side portion 24 decreases as the distance from the coupling portion 25 increases is formed on the inner side surface of the second vertical side portion 24 of the attachment base 21 of the roof weather strip 20, and the protruding portion 18 and the engagement portion 27 are engaged with each other, therefore, it is easy to insert the attachment base 21 on which the engagement portion 27 is formed into the mounting portion 17b of the weather strip attachment portion 17 on which the protruding portion 18 is formed.

Further, after the attachment base 21 is attached to the mounting portion 17b, even when a force in the front-rear direction of the vehicle 1 is applied to the attachment base 21 due to the deformation of the hollow seal portion 22 when the first panel 11 is opened and closed, the attachment base 21 can be prevented from moving in the front-rear direction of the vehicle 1.

Further, in general, a time period during which the first panel 11 is left in a closed state, that is, in a state where the hollow seal portion 22 and the first panel edge portion 11a are in contact with each other is generally long, and there is a case where the hollow seal portion 22 and the first panel edge portion 11a of the first panel 11 are fixed to each other, however, even in this case, since the protruding portion 18 and the engagement portion 27 are engaged with each other, even when the hollow seal portion 22 is pulled in a backward direction of the vehicle 1, and the attachment base 21 connected to the hollow seal portion 22 is pulled in the backward direction, it is possible to prevent the attachment base 21 from coming off from the weather strip attachment portion 17.

(6) In the present embodiment, the upper bulging portion 28 is formed on the outer side surface of the first vertical side portion 23 of the attachment base 21, the hardness of the upper bulging portion 28 is lower than that of the member constituting the attachment base 21, and the upper bulging portion 28 bends, deforms, and is in contact with the second panel lower surface 12b, therefore, the side of the first vertical side portion 23 of the attachment base 21 is biased against the weather strip attachment portion 17, whereby the attachment position of the roof weather strip 20 is stabilized.

Further, when the first panel 11 is opened, the upper bulging portion 28 is in contact with the second panel lower surface 12b even when water accumulated in a contact portion between the hollow seal portion 22 and the inclined surface 16 or water adhering to the hollow seal portion 22 flows to the inclined surface 16 or the side of the inclined surface 16 of the hollow seal portion 22, therefore, it is possible to prevent the flowing water from entering between the attachment base 21 and the weather strip attachment portion 17.

Further, even when the hollow seal portion 22 deteriorates over time and water enters between the hollow seal portion 22 and the inclined surface 16, it is possible to prevent water from entering between the attachment base 21 and the weather strip attachment portion 17.

(7) In the present embodiment, the lower bulging portion 29 is formed on the outer side surface of the second vertical side portion 24 of the attachment base 21, and even when the housing 40 is disposed below the second panel 12, the hardness of the lower bulging portion 29 is lower than that of the member constituting the attachment base 21, and the lower bulging portion 29 bends, deforms and is in contact with the housing step portion 41 of the housing 40, therefore, the side of the second vertical side portion 24 of the attachment base 21 is biased against the weather strip attachment portion 17, whereby the engagement between the engagement portion 27 and the protruding portion 18 can be reliably secured. Further, the attachment position of the roof weather strip 20 is stabilized.

Further, when the first panel 11 is opened, the lower bulging portion 29 is in contact with the housing step portion 41 even when the water accumulated in the contact portion between the hollow seal portion 22 and the first panel edge portion 11a or the water adhering to the hollow seal portion 22 flows along the side of the first panel 11 of the hollow seal portion 22 or when the water flowing along the side of the first panel 11 drops and bounces back at a lower position, therefore, it is possible to prevent the flowing water or bounced water from entering between the attachment base 21 and the housing 40.

(8) In the present embodiment, since the second panel 12 is made of resin, weight reduction can be achieved.

The implementation of the present invention is not limited to the above embodiment, and various modifications can be made without departing from the object of the present invention.

The roof weather strip 20 may be made of a thermoplastic elastomer, a soft synthetic resin, or the like in addition to EPDM. As the thermoplastic elastomer, in addition to TPV, an olefinic thermoplastic elastomer (TPO) is preferable from the viewpoints of weather resistance, recycling, cost, and the like.

What is claimed is:

1. An attachment structure for a roof weather strip, wherein
at least two panels are disposed on a roof of a vehicle,
a first panel is a movable panel configured to be able to open and close an opening portion of the roof,
a second panel is a fixed panel that is made of resin and fixedly disposed adjacent to a vehicle front side or a vehicle rear side of the first panel,
an inclined surface having an acute angle is formed at a second panel end portion of the second panel on a side of the first panel in a vehicle downward direction from the side of the first panel in a vehicle vertical direction,
a weather strip attachment portion having a substantially L-shaped cross section is formed in the vehicle downward direction from a second panel lower surface of the second panel and in the direction of the first panel,
the roof weather strip includes an attachment base having a substantially U-shaped cross section and a hollow seal portion connected to the attachment base, and
the attachment base is attached to the weather strip attachment portion.

2. The attachment structure for a roof weather strip according to claim 1, wherein
a protruding portion is formed in the weather strip attachment portion,
an engagement portion is formed inside an opening of the attachment base, and
the protruding portion and the engagement portion are engaged with each other.

3. The attachment structure for a roof weather strip according to claim 1, wherein
at least one of an upper bulging portion and a lower bulging portion is formed on a side surface on a non-opening side of the attachment base,
hardness of the upper bulging portion and the lower bulging portion is lower than hardness of a member constituting the attachment base,
the upper bulging portion is in contact with the second panel lower surface, and
the lower bulging portion is in contact with a housing disposed in the vehicle downward direction of the second panel.
